(19) United States
(12) Patent Application Publication
(10) Pub. No.: US 2008/0026223 A1
(43) Pub. Date: Jan. 31, 2008

(54) Anti-bacterial plastic floor tiles

(76) Inventor: Ko Chun-Shien, Kaoshiung Shein (TW)

Correspondence Address: TROXELL LAW OFFICE PLLC;SUITE 1404, 5205 LEESBURG PIKE, FALLS CHURCH, VA, 22041, US

(21) Appl. No.: 11/453,938

(22) Filed: Jun. 16, 2006

(51) Int. Cl. B32B 27/00; B32B 9/04; B32B 37/00

(52) U.S. Cl. 428/411.1; 156/272.2

(57) ABSTRACT

A method for manufacturing anti-bacterial plastic tiles includes steps of having the surface of half-finished plastic tiles coated with two layers of anti-bacterial UV sensitive resin, and then the two layers are photo cured by UV lights. Treated with such steps, the surface of the plastic tile is able to prevent bacteria from multiplying.

### BACKGROUND OF THE INVENTION

1. Field of the Invention

This invention relates to a method for manufacturing anti-bacterial plastic tiles, particularly to one having an anti-bacterial material and a UV sensitive resin together as a coating material to be coated on the surface of half-finished plastic tiles by means of rollers. Then, the UV sensitive resin mixed with the anti-bacterial material coated on the surface of the half-finished plastic tiles is photo cured by UV lights to adhere tightly to the surface of the plastic tiles. By repeating foresaid steps of coating and photo curing, multiple-layer anti-bacterial UV sensitive resin can be firmly glued on the surface of the plastic tiles, able to stop bacteria from multiplying.

2. Description of the Prior Art

Conventional floor tiles do not have the surface treated with an anti-bacterial substance; therefore, bacteria are likely to multiply on the surface of the conventional floor tiles.

It is necessary to restrain bacteria from multiplying in living surroundings in order to protect the aged and young from being infected by bacteria. Young children who spend much time contacting with floors before being able to walk and patients who has been operated need a living surroundings with less bacteria, but conventional tiles cannot offer such a living surroundings.

To sum up, conventional plastic tiles have the following disadvantages.

1. Conventional plastic tiles are not treated with an anti-bacterial substance on the surface, so they cannot effectively restrain bacteria from multiplying.

2. Conventional plastic tiles are provided with no protective layers on the surfaces, so they are likely to be worn off and produce depressions, thus shortening the service life of the plastic tiles.

### SUMMARY OF THE INVENTION

The objective of the invention is to offer a method for manufacturing anti-bacterial plastic tiles, including various steps of coating anti-bacterial UV sensitive resin on the surface of half-finished plastic tiles once by rollers, and then the UV sensitive resin is photo cured by UV lights. Subsequently, the surface of the half-finished plastic tiles are coated with anti-bacterial UV sensitive resin once again, and then this second-layer resin is also photo cured by UV lights. Treated with such steps, the surface of the plastic tiles is coated with multiple-layer anti-bacterial UV sensitive resin, able to prevent bacteria from multiplying.

### BRIEF DESCRIPTION OF DRAWINGS

This invention will be better understood by referring to the accompanying drawings, wherein:

FIG. 1 is a block diagram of a method for manufacturing anti-bacterial plastic floor tiles in the present invention;

FIG. 2 is a flow chart of the method for manufacturing anti-bacterial plastic tiles in the present invention;

FIG. 3 is partial magnified views of the A and the B indicated in FIG. 2;

FIG. 4 is a side cross-sectional view of an anti-bacterial plastic floor tile in the present invention; and

FIG. 5 is a perspective view of the anti-bacterial plastic floor tile in the present invention.

### DETAILED DESCRIPTION OF THE PREFERRED EMBODIMENT

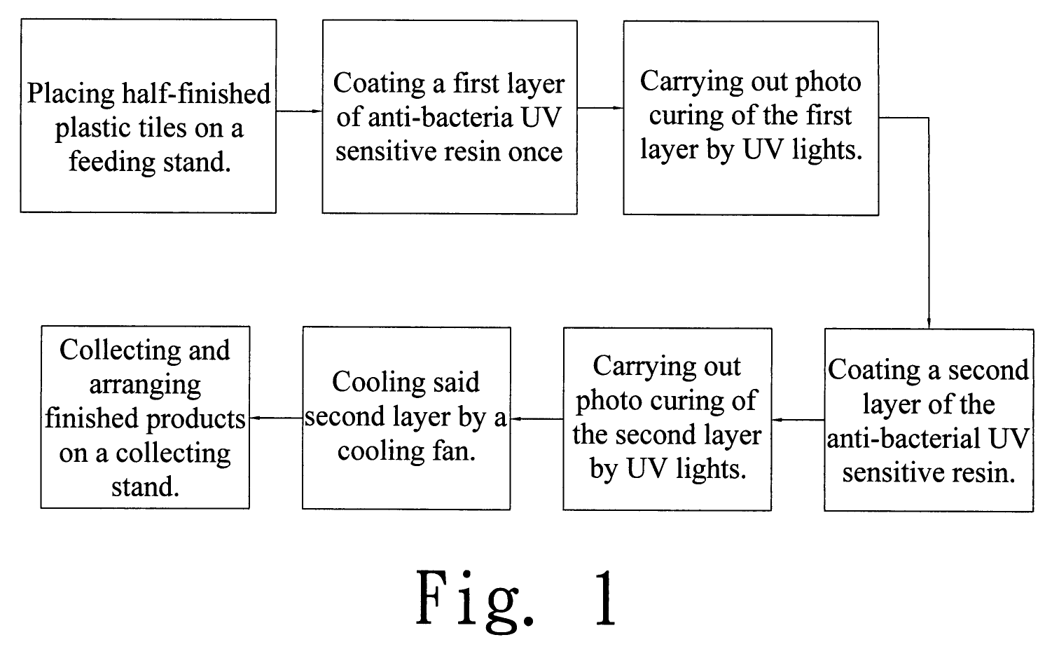

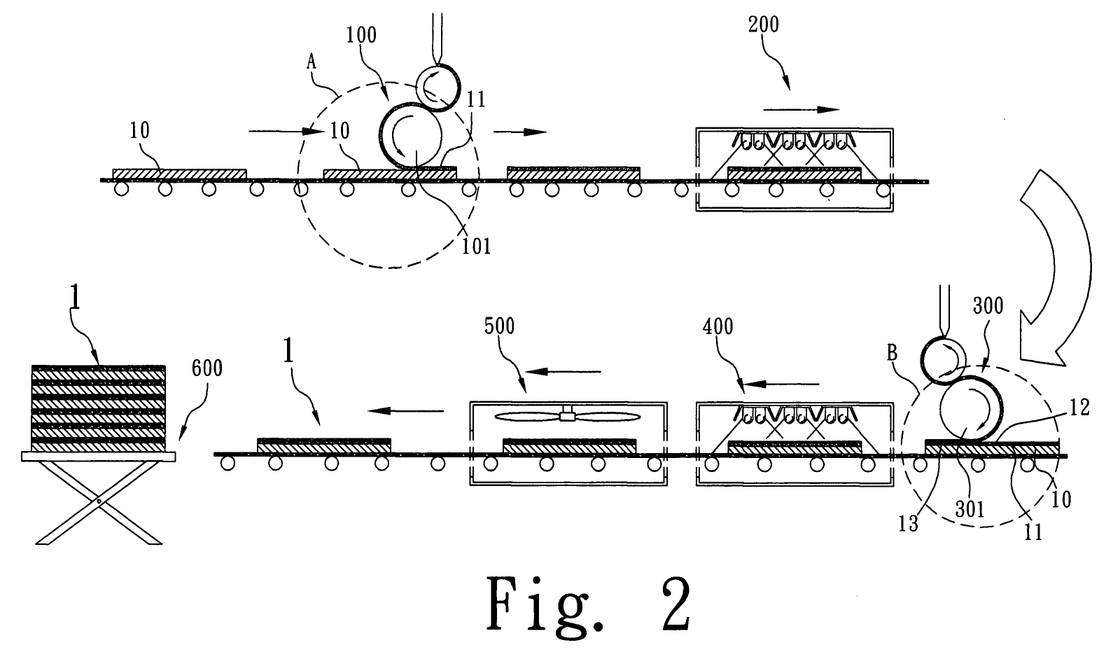

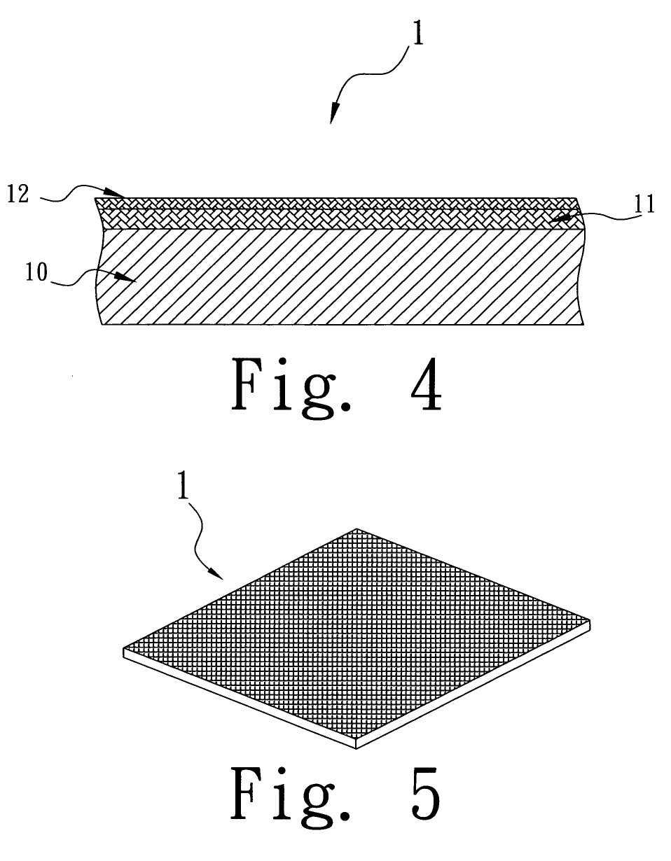

A preferred embodiment of a method of manufacturing anti-bacterial plastic tiles in the present invention, as shown in FIGS. 1 to 4, includes the following steps.

A first step is to place half-finished plastic tiles 10 on a feeding stand to be processed.

A second step is to use a set of coating device for evenly coating a layer of the anti-bacterial UV sensitive resin 11 on the surface of the half-finished plastic tiles 10 by way of a roller coating 101.

A third step is to employ one or more units of UV lights to carry out photo curing the layer of the anti-bacterial sensitive UV resin 11 coated on the half-finished plastic tiles 10 to let the anti-bacterial UV sensitive resin 11 produce chemical change and become solidified to completely adhere to the half-finished plastic tiles 10, not easy to be peeled off by an external force.

A fourth step is to use another set of coating device for coating a second layer of the anti-bacterial UV sensitive resin 12 on the anti-bacterial UV sensitive resin 11 coated on the first hardened layer of the half-finished plastic tiles 10 by means of roller coating 300,

A fifth step is to use one or more units of UV lights to carry out photo curing 400 the second layer of the anti-bacterial UV sensitive resin 12 that is not completely hardened to let the anti-bacterial UV sensitive resin 12 produce chemical change and solidified to be firmly covered on the first hardened layer of the anti-bacterial UV sensitive resin 11.

A sixth step is to cool off the second hardened layer of the anti-bacterial sensitive UV resin by a cooling fan.

Lastly, a seventh step is to collect and arrange the finished products of anti-bacterial plastic tiles 1 on a collecting stand 600.

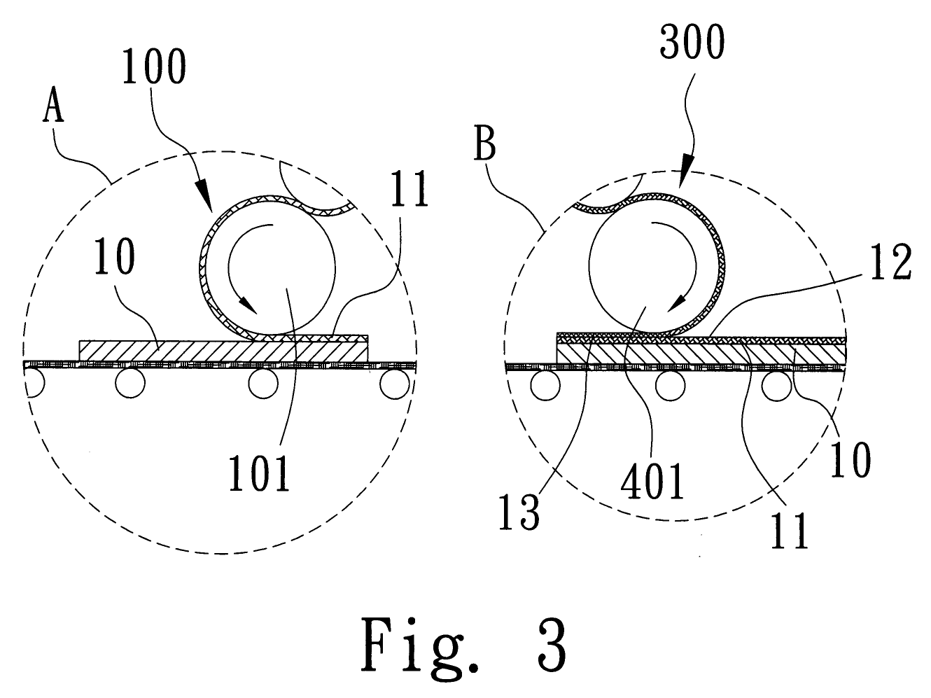

FIG. 3, which is partial magnified view of the (A) and (B) in FIG. 1, shows the condition (A) of the first roller coating 100 of the anti-bacterial UV sensitive resin 11 and the condition (B) of the second roller coating 300 of the anti-bacterial UV sensitive resin 12, which has an effect of anti-bacteria.

As can be understood from the above description, the anti-bacterial plastic tiles of this invention have the following advantages.

1. Coated with the anti-bacterial UV sensitive resin two times, the anti-bacterial plastic tile has an excellent effect of anti-bacteria.

2. Firmly coated on the plastic tile two times, the anti-bacterial UV sensitive resin can tightly be glued on the surface of the plastic tile, not easy to peel off.

In addition, in the coating process, this invention has some advantages as described below.

1. This invention covers the manufacturing of anti-bacterial plastic tiles.

2. In the course of processing, it is impossible to produce secondary waste, such as waste acid or additional acid clay, needless to worry about the sequent problem of disposing the secondary waste. Additionally, the wastewater produced in a rinsing process can be simply treated and recycled.

3. No acid cleaning process is needed in the processing of plastic tiles; therefore, it is needless to additionally provide any special device, lowering cost in both the device and the sequent maintenance.

While the preferred embodiment of the invention has been described above, it will be recognized and understood that various modifications may be made therein and the appended claims are intended to cover all such modifications that may fall within the spirit and scope of the invention.

I claim:

1. A method for manufacturing anti-bacterial plastic tiles comprising:
a first step of placing half-finished plastic floor tiles on a feed stand to be processed:
a second step of using a set of coating device for coating a first layer anti-bacterial UV sensitive resin on a surface of said half-finished plastic tile once:
a third step of photo curing said first layer of said anti-bacterial UV sensitive resin once by one or more units of UV lights:
a fourth step of employing another set of coating device for coating a second layer of said anti-bacterial UV sensitive resin on said first hardened layer of said anti-bacterial UV sensitive resin on said half-finished plastic tile once again:
a fifth step of photo curing said second-layer of said anti-bacterial UV sensitive resin by one or more units of UV lights:
a sixth step of using a cooling device for cooling off said second hardened layer of said anti-bacterial UV sensitive resin: and
the last seventh step of collecting and arranging said finished anti-bacterial plastic tiles on a collecting stand.

2. The method of manufacturing anti-bacterial plastic tiles as claimed in claim 1, wherein said coating device is a coating roller.

3. The method of manufacturing anti-bacterial plastic tiles as claimed in claim 1, wherein said coating device is able to firmly spread coating material on the surfaces of plastic floor tiles.

4. The method of manufacturing anti-bacterial plastic tiles as claimed in claim 1, wherein said UV sensitive resin mixed with an anti-bacterial material is coated on said half-finished plastic tiles two times, letting said plastic tiles able to restrain bacteria from multiplying.

5. The method of manufacturing anti-bacterial plastic tiles as claimed in claim 1, wherein said cooling device is a cooling fan.

6. The method of manufacturing anti-bacterial plastic tiles as claimed in claim 1, wherein said cooling process is dependent on a natural wind.

7. An anti-bacterial plastic tile formed with a protective layer on the surface, said protective layer composed of resin and anti-bacterial material.
